(19) United States
(12) Patent Application Publication
(10) Pub. No.: US 2007/0168750 A1
(43) Pub. Date: Jul. 19, 2007

(54) End-user signal analysis programming

(76) Inventors: William R. Wheeler, Southborough, MA (US); Thomas R. Clancy, Sterling, MA (US)

Correspondence Address: Lee & Hayes, PLLC;PortfolioIP, P.O. Box 52050, Minneapolis, MN, 55402, US

(21) Appl. No.: 11/321,485

(22) Filed: Dec. 29, 2005

(51) Int. Cl. G06F 11/00

(52) U.S. Cl. 714/39

(57) ABSTRACT

Described herein is a logic analysis system that allows a user to analyze waveforms using programs created or supplied by the user of the system.

### TECHNICAL FIELD

The following description relates to analyzing signal timing and relationships.

### BACKGROUND

Designing complex circuits such as semiconductor integrated circuits entails lengthy testing and debugging. During such debugging, it is useful for designers to view visual representations of various circuit signals over time. Hardware and software for this purpose are widely available, referred to as logic analyzers, logic analysis software, waveform viewers, waveform editors, etc. In some cases, signal waveforms are captured by attaching probes to physical devices and recording voltage within the devices. In other situations, representations of waveforms are generated by circuit emulators, which predict hardware operation through mathematical analysis.

Waveforms are often presented to users in the form of a graph, with time on the horizontal axis and voltage or logic levels on the vertical axis. Multiple waveforms are often displayed in a vertical arrangement, along a common timeline so that interactions between signals can be studied. The waveform can be scrolled horizontally along the time axis, and the user can specify different scales for the time axis. Waveform viewers sometimes have additional functions that allow a user to search for a particular type of event, such as a signal transition. Such functions might include, for example, a Zoom-In/Zoom-Out function to make the waveforms smaller/larger depending on viewing preferences, a print function, functions to move and put waveforms into logical groups to facilitate visual comparisons of waveforms, and so forth.

However, even with tools such as these, it can be difficult and tedious to determine specific cause and effect relationships between various signals.

### BRIEF DESCRIPTION OF THE DRAWINGS

FIG. 1 is a block diagram showing relevant components of a logic analyzer having a user programmable component.

FIG. 2 is a simplified block diagram of a computer system on which the logic analyzer of FIG. 1 can be implemented.

FIG. 3 is a simplified representation of a graphical user interface implemented by the logic analyzer of FIG. 1.

FIG. 4 is a flowchart showing methodological operation of the logic analyzer of FIG. 1.

### DETAILED DESCRIPTION

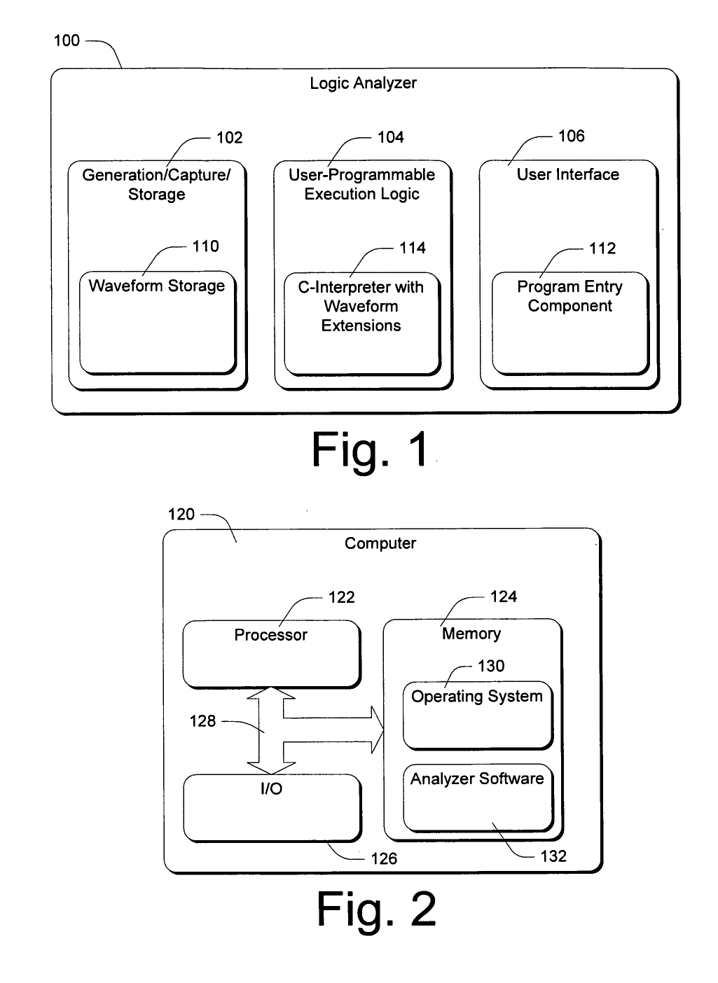

FIG. 1 shows relevant portions of a logic or signal analyzer system, generally designated by reference numeral 100. Relevant components of analyzer 100 include a waveform generation/capture/storage component 102, a user-programmable analysis or execution component 104, and a user interface 106.

Waveform generation/capture/storage component 102 comprises circuit or logic emulation software that generates digital representations of one or more waveforms in response to a simulated electrical or logic circuit specification. Alternatively, generation/capture/storage component 102 can comprise a probe system that connects physically to an in-test circuit and that measures circuit values during actual operation of the circuit. In either case, component 102 includes waveform storage 1 10 that stores representations of one or more waveforms—whether those waveforms result from circuit simulation or measurement of physical circuit signals. Furthermore, the stored waveforms or waveform representation need not necessarily originate from system 100 itself. Instead, they may be generated or captured using some different mechanism, then transferred to or stored in waveform storage 110. Typically, waveform representations are stored as one or more digital computer files, using conventional file storage techniques and devices such as magnetic and/or optical storage media.

User interface 106 comprises a graphical display and user input components, such as a monitor, keyboard, mouse, touch-sensitive monitor, and/or other types of components commonly used for interaction between a computer and a human user of a computer-based system. The user interface includes images that are presented to the user such as visual waveform representations, prompts, menus, and other information. In particular, user interface 106 includes a program entry component or element 112, which interacts with a user to allow the user to create or enter programs that reference and analyze stored waveforms.

Analysis component 104, alternatively referred to as execution logic, is a program or logic component that is programmable by the user to analyze one or more waveforms stored by waveform generation/capture/storage component 102.

Conventionally, analysis component 104 has predefined functions that an operator can select to perform different measurements or other operations with respect to the stored waveforms. In accordance with the techniques described herein, however, execution logic 104 also includes a C-language interpreter 114 that can be instructed to execute user programs created and/or designated by the user. Specifically, analysis component 104 operates in conjunction with user interface 106 to accept designations—from the user—of user-defined programs to analyze stored waveforms. As will be described below, the user can create custom programs, using an extension of the C programming language, to analyze and detect specific waveform events and inter-relationships between waveforms. Such programs are entered or designated by way of user interface 106, and then executed by analysis component 104 at the request of the user to produce information about the waveforms as defined by the program with reference to the waveforms. Results generated by the program are then displayed by user interface 106. This allows the user to perform many different types of analyses, not limited to the predefined functions that might be provided by a conventional analyzer.

Although the example described herein uses a C-language interpreter, similar functionality can also be implemented using other programming languages such as BASIC, C++, Java, and others.

In addition to the components specifically shown in FIG. 1, system 100 includes components and functionality that are normally found in such systems in order to implement conventional and common functions of a logic analyzer. This typically includes application-specific software to implement such conventional functionality.

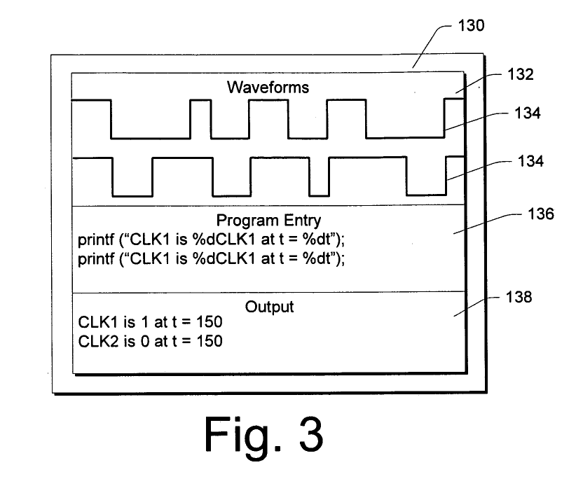

FIG. 2 shows an example of a computer system 120 on which analyzer 100 can be implemented. Computer 120 in this example is a conventional desktop computer, having one or more processor 122, one or more computer-readable storage media 124, and I/O components 126. These components communicate by way of a system bus 128.

Processor 122 is a conventional microprocessor such as found in typical desktop computers. Computer-readable storage media 124 comprises various types of memory, such as volatile electronic read/write memory, non-volatile electronic read-only memory, magnetic media such as a hard disk, and removable storage media such as diskettes, CD-ROMs, etc. Generally, software is distributed on removable media and installed from there onto a computer hard disk or other memory (possibly remote) that is readily accessible by computer system 120. At or during execution, the software is loaded from the hard disk to electronic memory for execution. During execution, processor 122 retrieves instructions from the electronic memory and executes them. The computer typically runs under the supervision of an operating system, which coordinates these operations, in addition to facilitating user I/O.

I/O components 26 typically comprise a monitor, a keyboard, and a pointing device such as a mouse, although other components might be used for interaction with the user of the computer. In addition, I/O components typically include various communications ports for use with printers, networks, and so forth. Such I/O components might optionally include hardware for measuring actual signal or logic levels within an external in-test circuit, or might include a communication port for receiving waveform files from other computers or instruments. Waveform files might also be transferred to computer 120 by way of portable storage media such as CD-ROMs.

Software components of computer 120 are shown as blocks within computer-readable memory 124, although it is recognized that such software resides in various different types of memory within computer 120 at various times, and is actually executed by processor 122. In this example, the software includes an operating system 130 and logic analysis software 132, although other types of software are likely co-exist on computer 120. Note also that logic analysis software might initially reside on some type of portable media, such as a CD-ROM, before it is installed on non-removable media of computer 120. The functionality described above with reference to FIG. 1 and in the discussion that follows is implemented or facilitated by logic analysis software 132, in conjunction with the computer operating system.

Note that although the system is described as being implemented on a conventional desktop computer, other forms of implementation are also contemplated. For example, many different types of computers or computer-based devices can be used to implement the described logic analysis system. Furthermore, such a system might be implemented as a dedicated purpose test instrument rather than in conjunction with a general-purpose computer.

FIG. 3 shows a rudimentary example 130 of a graphical portion of a user interface such as might be presented by logic analyzer 100 for interaction with a user. Graphical user interface 130 includes a graphical waveform area 132 on which are displayed one or more waveforms 134 for viewing by the user. The waveforms are presented in a graph-type format, with time along the horizontal axis (common to all displayed waveforms) and voltage or logic levels along the vertical axis. Controls (not shown) are provided to allow the user to scroll horizontally through the waveforms, to change the scale of the horizontal time axis, to specify which waveforms are displayed, and so forth, in accordance with normal logic analyzer functionality.

In addition to the waveform area, user interface 130 includes a user-program area 136. In contrast to more conventional analyzers which limit users to predefined measurement functions or sequences, program area 136 interacts with the user to define, identify, or accept user specified programs to be executed with reference to the stored and/or or displayed waveforms 134. In this example, programs are created and formatted by the user of the logic analyzer in accordance with an extension of the C programming language created and defined by the inventors. Special syntax is defined that allows the program to reference the waveforms, such as accessing waveform values by time and identifying specified waveform events. The extended C language in this embodiment allows conditional flow statements, and such conditional flow statements can reference the displayed or stored waveforms so that program operation and logic is dependent on characteristics of the waveforms. In addition, results of any programmatic analysis can be output to the user interface 130.

User interface 130 includes a program results area 138. Results of output statements in user-specified programs are displayed in this area. Alternatively, such results can be displayed in a pop-up window or balloon that overlays waveform 132 or some other area of the user interface. Note that these are only examples of how such program output might be handled, and many other arrangements of user interface 130 are possible and may be desirable. Most implementations will involve many more controls and display components in order to impart the desired functionality to logic analyzer 100: to load waveforms, set display options, execute programs, initiate emulation, etc. In relation to the user programmability discussed herein, the user interface is likely to have controls that allow a user to save and retrieve user-specified programs, and possibly to manipulate or deal with such programs in other ways. Furthermore, the controls will provide a way for the user to request execution of the currently loaded program.

As noted above, analysis component 104 in this implementation comprises or includes a C-language interpreter, configured to accept C-language programs with extensions, and to execute those programs with reference to the currently displayed or stored waveforms. Programs can be created and entered by a user directly into the user-program area 136. Alternatively, programs can be created using some other tool or editor, then loaded and executed by logic analyzer 100 at the user's request, by use of control elements (not shown) of user interface 130.

Having described the general concepts and functional characteristics of logic analyzer 100, the following discussion relates to C language extensions defined by the inventors and utilized to allow user-specified programs to reference waveforms and to output analysis results.

In the described implementation, user-defined programs can utilize a variable t, which is predefined by execution logic 104 as an integer representing time, corresponding to the horizontal axis of waveform area 132. Variable t may be configured to use a convenient time scale, such as nanoseconds, microseconds, or milliseconds. The desired time scale will often depend on how the waveform file was captured. When used as an argument, t specifies the point along the horizontal axis of the stored waveforms at which the specified measurements or other analysis will be performed.

Displayed waveforms are named in accordance with normal operation of the logic analyzer and/or the emulation logic that generates the waveforms. Execution logic 104 is configured to use variable names for the waveforms corresponding to the names of the waveforms as displayed on the user interface: any currently loaded waveform is treated as a global numeric variable when it appears in a C statement or expression. Thus, assuming a waveform is named CLK1, the value of the waveform is referenced within a user-specified program simply as variable CLK1. The following statement is used to print the value of CLK1:
print f(CLK1);

This outputs the value of signal CLK1 at a time equal to the current value of t.

The following C code outputs the value of CLK1 at every value of t from 0 to 199:

for (t=0; t<200; t++)

{
printf(“at t=%d, CLK1=%d\n, t, CLK1)
}

Execution logic 104 also recognizes a pre-defined operator “@”. Although this is not a standard C operator, the C interpreter of execution logic 104 recognizes this operator to evaluate a signal at a specific time, in accordance with the following syntax:
sig@time

where sig specifies a particular waveform by name and time specifies a time value relative to the waveform. As an example, the preceding example can be modified using this operator to print only those values of CLK1 that represent a change from the previous value:

for(t=1; t<200; t++)

{
if (CLK1 != CLK1@(t−1))

printf(“at t=%d, CLK1=%d\n, t, CLK1)

}

The defined extensions to the C language allow user-defined, automated analysis of waveforms, including individual and relative timings of the waveforms. In addition, the C interpreter includes several pre-defined functions that make such analysis much easier to program. In combinations, these capabilities allow automation of many measurement procedures that were previously required to be accomplished strictly by visual inspection of the displayed waveforms.

One such predefined function, named “next_transition”, returns a time corresponding to the next waveform transition following a specified time value. It expects two arguments: a signal name and a time value. For example, the following statement outputs the time value of the first signal transition of CLK1 following t=100:
printf(next_transition(CLK1, 100));

Another predefined function, named “num_transitions”, returns the number of transitions of a specified waveform within a specified time period. It expects four arguments; a waveform name, a transition value, an end time, and a start time. It returns the number of transitions of the specified waveform to the transition value between the start and end times. For example, the following statement outputs the number of times signal CLK1 transitions to “1” from time 100 to time 200:
printf(num_transitions(CLK1, 1, 100, 200));

A predefined function named “find_transition” returns the time at which the last of a specified number of transitions occurs to a specified transition value. It expects four arguments: a waveform name, a transition value, a start time, and a number of transitions. For example, the following statement outputs the time at which signal CLK1 transitions to “1” for the 100^{th} time, starting at t=50:
printf(find_transition(CLK1, 1, 50, 100));

In many instances, signal or waveforms can comprise multiple bits. In these situations, specific bit ranges can be specified by supplying two arguments to a waveform variable name, such as name(msb, lsb), where msb indicates the most significant bit of the desired bit range, and lsb indicates the least significant bit. Waveforms can exist as arrays, in which case three arguments are supplied with the variable name: name(array_index ,msb, lsb), where array_index is the array index. lsb is optional and defaults to the value supplied for msb. If neither lsb nor msb are supplied, the entire bit range of the waveform is assumed.

Other functions can of course be supplied to facilitate waveform analysis. For example, a particular implementation might include functions for determining the bit width of a named waveform; for associating different names with waveforms or bit fields of waveforms; for returning particular bits of a waveform, such as the most significant or least significant bit; for determining the maximum recorded time in a set of loaded waveforms, etc.

As another enhancement, the value t=0 can be set by the user relative to the actual start of the waveform, prior to actually executing a program. For example, the user may want to run a program that analyzes a waveform starting at a time 100 within the current waveform. If this is the case, the user can specify that for purposes of the program, t is considered equal to 0 at an actual time of 100 relative to the beginning of the waveform. Furthermore, variable t can be considered equal to 0 at a relative time along the waveform corresponding to position of a user-controlled cursor positioned graphically over the displayed waveforms. This allows a user to easily run the program multiple times, starting at different points along a displayed waveform or set of waveforms.

Note that the program examples and techniques described above are merely examples of what an end-user can do when using this technology. The defined syntax and functions can be used to accomplish many different types of automated analyses.

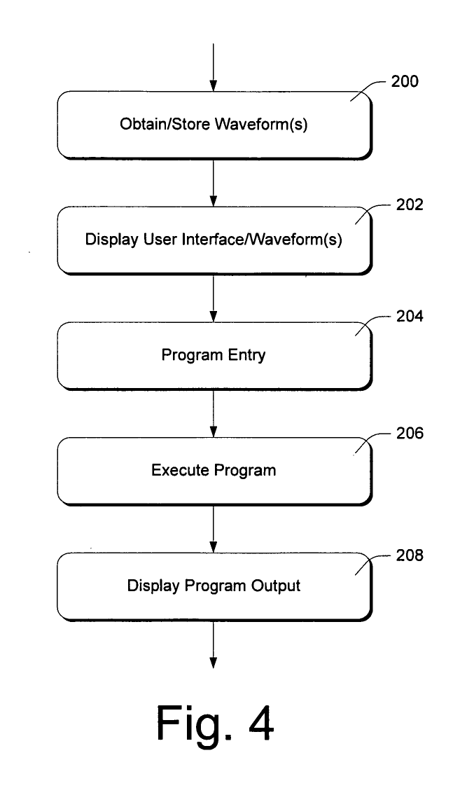

FIG. 4 illustrates methodological aspects of the described system's operation. Block 200 comprises obtaining or storing a set of one or more signal waveforms. Such waveforms can be generated by emulation, or they may result from actual sampling. Furthermore, the waveforms may represent either digital or analog values. In the case of digital values, the signals may comprise single bit lines or sets of multiple bit lines.

Block 202 comprises displaying a user interface to the user, which will typically include displaying the stored set of waveforms. The waveforms are displayed as described above, allowing the user to scroll through the waveforms horizontally, along a time axis. Other viewing options may be available depending on the particular implementation of the logic analyzer.

Block 204 comprises accepting a designation by a user of a program to be executed against the displayed and/or stored set of waveforms. This may comprise interacting with the user to actually create the program, or may comprise simply allowing the user to specify a location of a previously created program. The program can contain statements formatted in accordance with the C-language extensions described above, with other extensions, or using other programming languages.

Block 206 comprises executing the designated program at the user's request.

Block 208 comprises displaying output generated by the executed or executing program.

Although described in language more or less specific as to structural and methodical features, it is to be understood that the invention is not limited to the specific features described. The invention is, therefore, claimed in any of its forms or modifications within the proper scope of the appended claims appropriately interpreted in accordance with the doctrine of equivalents.

1. A logic analyzer comprising:
waveform storage configured to store a representation of one or more waveforms;
a user interface configured to accept a program created by a user of the logic analyzer, wherein the program contains statements that reference said one or more waveforms; and
execution logic that executes the program when requested by the user and that produces information about said one or more waveforms, said information being defined by the program with reference to said one or more waveforms.

2. A logic analyzer as recited in claim 1, wherein the user interface displays said one or more waveforms for viewing by the user.

3. A logic analyzer as recited in claim 1, wherein the user interface displays said one or more waveforms for viewing by the user and allows the user to scroll through said one or more waveforms.

4. A logic analyzer as recited in claim 1, wherein:
the execution logic executes the program relative to a time reference that is specified in the program.

5. A logic analyzer as recited in claim 1, wherein:
the execution logic executes the program relative to a time reference, and
the time reference is a function of any one or more of (a) the beginning of said one or more waveforms, (b) a time specified by the program, and (c) a time indicated by position of a user-controlled cursor relative to a visual presentation of said one or more waveforms.

6. A logic analyzer as recited in claim 1, wherein the program executed by the execution logic can contain a statement that returns a time corresponding to a specified waveform transition.

7. A logic analyzer as recited in claim 1, wherein the program executed by the execution logic can contain a statement that returns a time corresponding to the next waveform transition following a specified time value.

8. A logic analyzer as recited in claim 1, wherein the program executed by the execution logic can contain a statement that returns the number of transitions of a specified waveform within a specified time period.

9. A logic analyzer as recited in claim 1, wherein the program executed by the execution logic can contain statements that reference a waveform as follows:
sig@time
where sig specifies a particular waveform by name, time specifies a time value relative to the waveform, and @ is a predefined operator.

10. A logic analyzer as recited in claim 1, wherein the program executed by the execution logic can contain conditional flow statements that reference said one or more waveforms.

11. A method comprising:
displaying one or more waveforms to a user;
executing a program provided by the user to produce information about said one or more waveforms, said information being defined by the program with reference to said one or more waveforms.

12. A method as recited in claim 11, further comprising:
allowing the user to scroll through said one or more waveforms.

13. A method as recited in claim 11, further comprising:
presenting a user interface for interaction with the user to enter the program.

14. A method as recited in claim 11, wherein said executing is performed relative to a time reference that is specified in the program.

15. A method as recited in claim 11, wherein:
said executing is performed relative to a time reference that is specified in the program, and
the time reference is a function of any one or more of (a) the beginning of said one or more waveforms, (b) a time specified by the program, and (c) a time indicated by position of a user-controlled cursor relative to a visual presentation of said one or more waveforms.

16. A method as recited in claim 11, further comprising displaying a time corresponding to a waveform transition specified in a statement of the program.

17. A method as recited in claim 11, further comprising displaying a time corresponding to the next waveform transition following a time value specified in a statement of the program.

18. A method as recited in claim 11, further comprising displaying the number of transitions of a waveform specified in a statement of the program

19. A method as recited in claim 11, wherein the program can contain statements that reference a waveform as follows:
sig@time
where sig specifies a particular waveform by name, time specifies a time value relative to the waveform, and @ is a predefined operator.

20. A method as recited in claim 11, wherein the program executed by the execution logic can contain conditional flow statements that reference said one or more waveforms.

21. One or more computer-readable media containing a signal analyzer operating program, the operating program having instructions that are executable by a computer to perform actions comprising:
presenting a user interface that interacts with a user to display one or more waveforms, the user interface allowing the user to enter a user program containing statements that reference said one or more waveforms;
executing the user program in response to a user request to produce information about said one or more waveforms, said information being defined by the user program with reference to said one or more waveforms.

22. One or more computer-readable media as recited in claim 21, wherein said executing is performed relative to a time reference that is specified in the user program.

23. One or more computer-readable media as recited in claim 21, wherein:
said executing is performed relative to a time reference that is specified in the user program, and
the time reference is a function of any one or more of (a) the beginning of said one or more waveforms, (b) a time specified by the user program, and (c) a time indicated by position of a user-controlled cursor relative to a visual presentation of said one or more waveforms.

24. One or more computer-readable media as recited in claim 21, the actions further comprising displaying a time corresponding to a waveform transition specified in a statement of the user program.

25. One or more computer-readable media as recited in claim 21, the actions further comprising displaying a time corresponding to the next waveform transition following a time value specified in a statement of the user program.

26. One or more computer-readable media as recited in claim 21, the actions further comprising displaying the number of transitions of a waveform specified in a statement of the user program

27. One or more computer-readable media as recited in claim 21, wherein the user program can contain statements that reference a waveform as follows:
sig@time
where sig specifies a particular waveform by name, time specifies a time value relative to the waveform, and @ is a predefined operator.

28. One or more computer-readable media as recited in claim 21, wherein the user program can contain conditional flow statements that reference said one or more waveforms.
